(19) United States
(12) Patent Application Publication
(10) Pub. No.: US 2009/0113510 A1
(43) Pub. Date: Apr. 30, 2009

(54) Band Switchable Taps and Amplifier for Use in a Cable System

(76) Inventors: Paul Gothard Knutson, Lawrenceville, NJ (US); Max Ward Muterspaugh, Indianapolis, IN (US); Kumar Ramaswamy, Princeton, NJ (US)

Correspondence Address: Robert D. Shedd;Thomson Licensing LLC, PO Box 5312, PRINCETON, NJ, 08543-5312, US

(21) Appl. No.: 12/083,293

(22) PCT Filed: May 31, 2006
(86) PCT No.: PCT/US2006/021051

§ 371 Date: Apr. 9, 2008

Related U.S. Application Data
(60) Provisional application No. 60/725,795, filed on Oct. 12, 2005.

(51) Int. Cl. H04N 7/173

(52) U.S. Cl. 725/127

(57) ABSTRACT

A cable network tap comprises a first port for coupling to an upstream portion of a cable network and for receiving a downstream signal; a second port for coupling to a downstream portion of the cable network and receiving an upstream signal; and a filter for filtering at least one of the downstream signal and the upstream signal. The filter has a bandwidth that is adjustable in accordance with a plurality of cable network bandwidth configurations, each cable network bandwidth configuration allocating bandwidth differently between upstream communications and downstream communications over at least a portion of the cable network.

### BACKGROUND OF THE INVENTION

The present invention generally relates to communications systems and, more particularly, to cable television systems.

Current cable television (TV) systems offer a number of services to customers such as TV programming (both network and local), pay-per-view programming and Internet access. One example of a cable TV system is a hybrid fiber/coax based network that has a bandwidth capacity of 750 MHz (millions of hertz), or more, for delivering these services to their subscribers. This bandwidth capacity is typically divided between a down stream channel and an upstream channel. The downstream channel conveys not only the TV programming but also the downstream Internet data communications to each subscriber; while the upstream channel conveys the upstream Internet data communications from each subscriber.

### SUMMARY OF THE INVENTION

The above described distribution of cable TV bandwidth into a downstream channel and an upstream channel is fixed. As a result, this makes it difficult for cable operators to extend the capabilities of their cable networks or to offer new types of services that require additional bandwidth. However, we have realized that it is possible for a cable system to manage the bandwidth the bandwidths of the upstream and downstream channels—thus enabling the cable system to offer new capabilities and services. In particular, and in accordance with the principles of the invention, a cable system manages bandwidth by selecting a bandwidth in accordance with a selected one of a plurality of cable network bandwidth configurations, each cable network bandwidth configuration allocating bandwidth differently between upstream communications and downstream communications over at least a portion of the cable network; and filtering at least one signal (e.g., a downstream signal or an upstream signal of the cable network or both of these signals) in accordance with the selected bandwidth.

In an illustrative embodiment of the invention, a portion of a cable network includes an apparatus, e.g., a tap, comprising a first port for coupling to an upstream portion of a cable network and for receiving a downstream signal; a second port for coupling to a downstream portion of the cable network and for receiving an upstream signal; and a filter for filtering at least one of the downstream signal and the upstream signal; wherein the filter has a bandwidth that is adjustable in accordance with a plurality of cable network bandwidth configurations, each cable network bandwidth configuration allocating bandwidth differently between upstream communications and downstream communications over at least a portion of the cable network.

### BRIEF DESCRIPTION OF THE DRAWINGS

FIG. 1 shows an illustrative cable system in accordance with the principles of the invention;

FIGS. 2-10 illustrate bandwidth management in accordance with the principles of the invention;

FIGS. 11-13 show illustrative embodiments of a programmable bandwidth device in accordance with the principles of the invention;

FIG. 14 shows another illustrative cable system in accordance with the principles of the invention;

FIG. 15 shows another illustrative embodiment of a programmable bandwidth device in accordance with the principles of the invention; and

FIGS. 16-20 show other illustrative embodiments of a programmable bandwidth device in accordance with the principles of the invention.

### DETAILED DESCRIPTION

Other than the inventive concept, the elements shown in the figures are well known and will not be described in detail. Also, familiarity with television broadcasting and receivers in the context of terrestrial, satellite and cable is assumed and is not described in detail herein. For example, other than the inventive concept, familiarity with current and proposed recommendations for TV standards such as NTSC (National Television Systems Committee), PAL (Phase Alternation Lines), SECAM (SEquential Couleur Avec Memoire) ATSC (Advanced Television Systems Committee) (ATSC) and ITU-T J.83 “Digital multi-programme systems for television, sound and data services for cable distribution” is assumed. Likewise, other than the inventive concept, familiarity with satellite transponders, cable head-ends, set-top boxes, downlink signals and transmission concepts such as eight-level vestigial sideband (8-VSB), Quadrature Amplitude Modulation (QAM), out-of-band control channels and receiver components such as a radio-frequency (RF) front-end, or receiver section, such as a low noise block, tuners, and demodulators is assumed. Similarly, formatting and encoding methods (such as Moving Picture Expert Group (MPEG)-2 Systems Standard (ISO/IEC 13818-1)) for generating transport bit streams are well-known and not described herein. It should also be noted that the inventive concept may be implemented using conventional programming techniques, which, as such, will not be described herein. Finally, like-numbers on the figures represent similar elements.

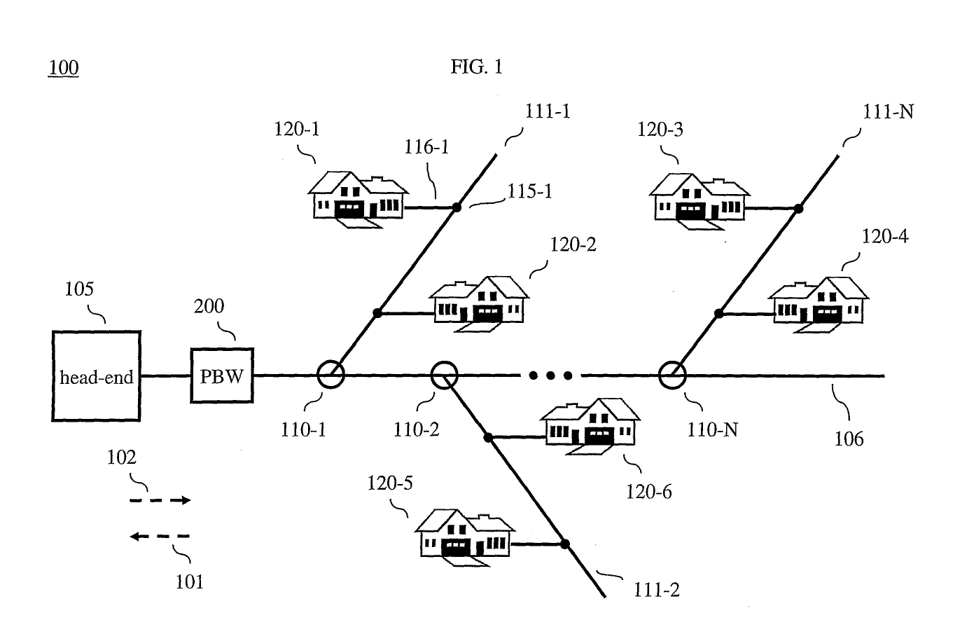

Turning now to PIG. 1, an illustrative cable system 100 in accordance with the principles of the invention is shown. Illustratively, cable system 100 is a hybrid-fiber coax (HFC) system. For simplicity, the fiber portion is not described herein. It should be noted that although the inventive concept is described in the context of coaxial cable (coax), the inventive concept is not so limited and can be extended to the processing of fiber optic signals. A plurality of stations, as represented by stations 120-1 to 120-6, are connected to a common head-end 105 by a tree and branch cable network. Each station is associated with a cable subscriber. Each station includes, e.g., a set top box for receiving video programming and a cable modem for bi-directional data communications to, e.g., the Internet. Head-end 105 is a stored-program-processor based system and includes at least one processor (e.g., a microprocessor) with associated memory, along with a transmitter and receiver coupled to the cable network (for simplicity, theses elements are not shown). Ignoring for the moment element 200, the cable network comprises a main coaxial cable 106 having a plurality of taps 110-1, 110-2 to 110-N. Each of these taps serves a corresponding feeder cable. For example, tap 110-1 serves feeder cable 111-1. Each feeder cable in turn serves one, or more, stations via a tap and a drop. For example, feeder cable 111-1 serves station 120-1 via tap 115-1 and drop 116-1. For the purposes of this description, it is assumed that the devices of cable network 100, e.g., taps, drops, etc., are addressable and controllable by head-end 105 via an out-of-band signaling channel (not shown in FIG. 1). Other than the inventive concept, the use of an out-of-band signaling channel to address and control devices in particular portions of the cable network is known. For example, an out-of-band control channel that is a frequency shift keying (FSK) based can be used for both addressing and control of devices in a cable network. One such system is the Addressable Multi-Tap Control System available from Blonder Tongue Laboratories, Inc.

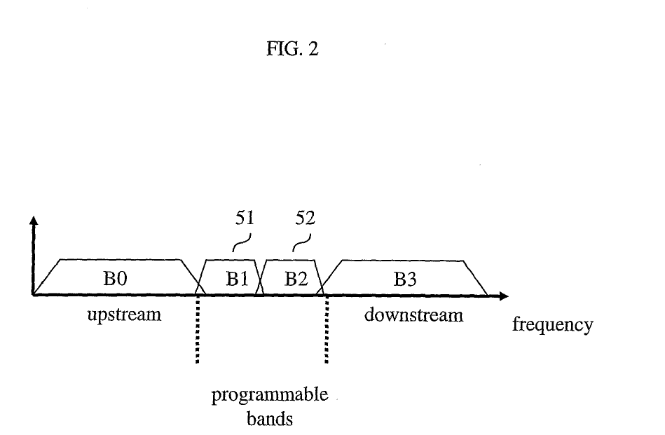

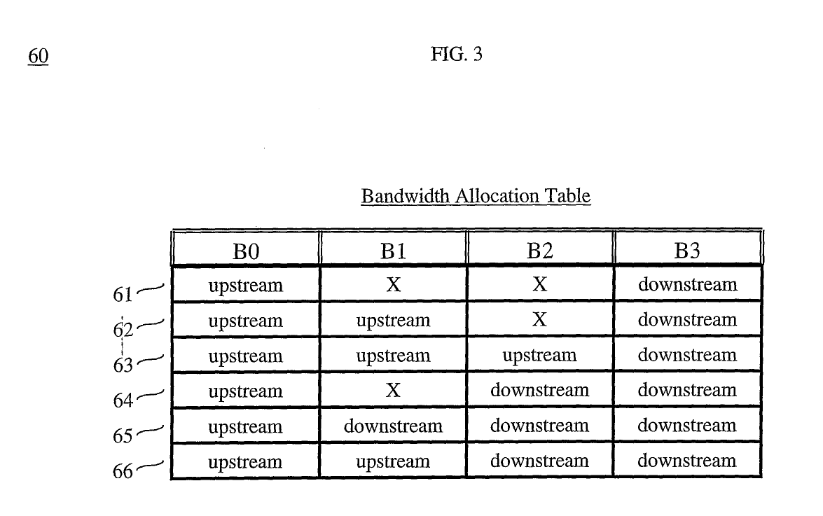

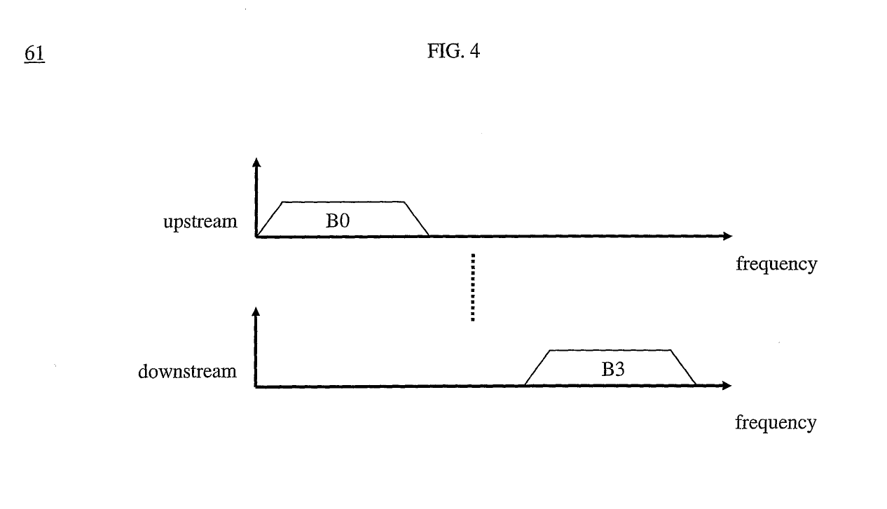

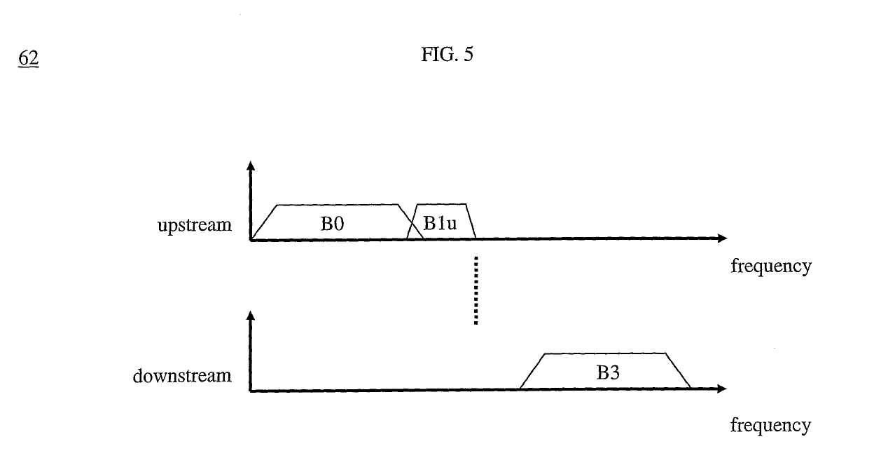

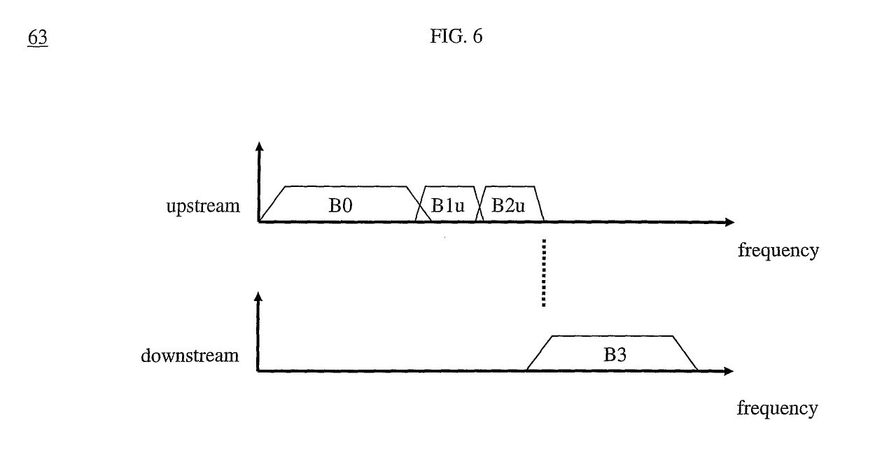

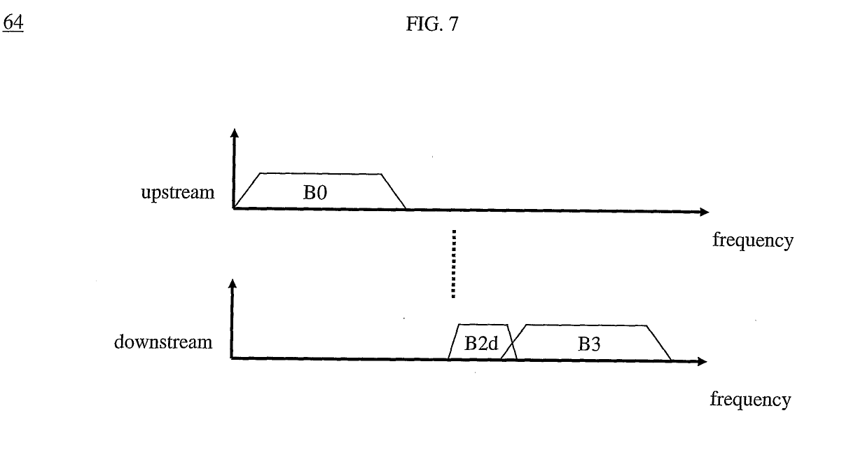

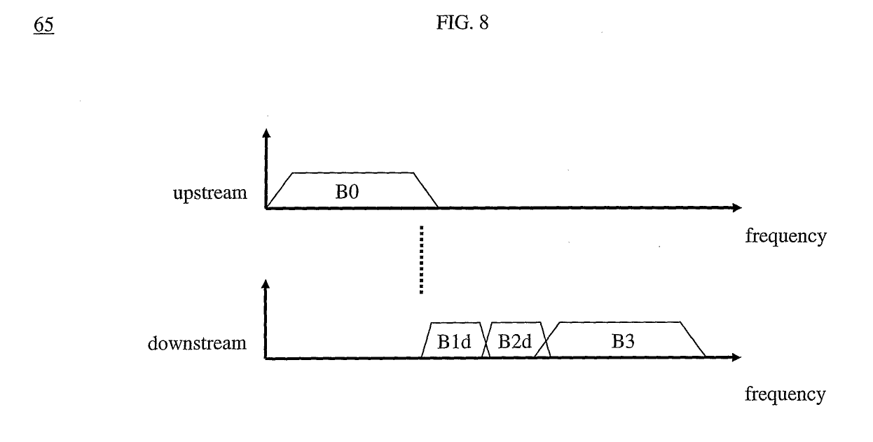

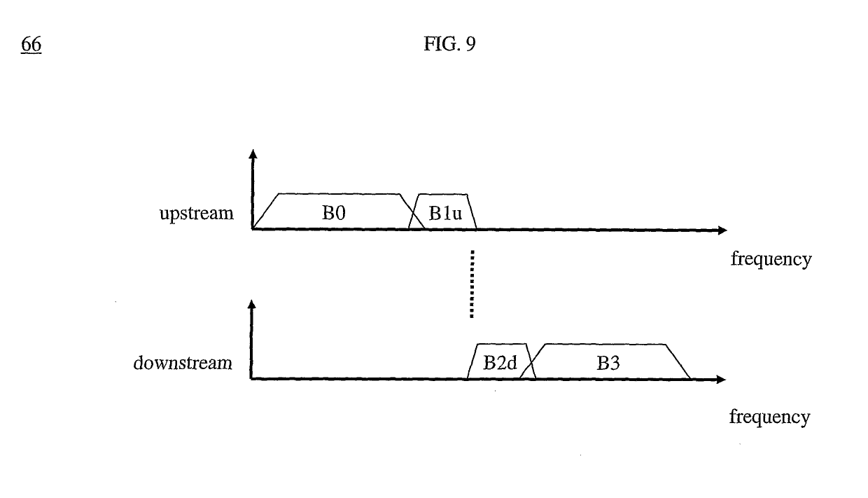

In cable system 100, communications between head-end 105 and the various stations occurs in both an upstream direction and a downstream direction. The upstream direction is towards head-end 105 as represented by the direction of arrow 101 and the downstream direction is towards the stations as represented by the direction of arrow 102. In accordance with the principles of the invention, cable system 100 includes at least one device that includes a programmable bandwidth (PBW) function (referred to herein as a PBW device). One, or more, of these PBW devices are used to manage the bandwidth in the cable system. This is further illustrated in FIG. 1 by PBW device 200, which is illustratively located in the main coaxial cable 106. However, the inventive concept is not so limited and a device including the PBW function can be located in any portion of the cable network. In accordance with the principles of the invention, the bandwidth of cable system 100 is divided into a number of bands as illustrated in FIG. 2. There is a fixed upstream band B0 for upstream communications, a fixed downstream band B3 for downstream communications and a number of programmable bands, as represented by B1 and B2. Illustratively, the programmable bands are arranged between upstream band B0 and downstream band B3, but the inventive concept is not so limited. Head-end 105 stores a bandwidth configuration table, which stores a plurality of cable network bandwidth configurations, each cable network bandwidth configuration allocating bandwidth differently between upstream communications and downstream communications over at least a portion of the cable network. In this regard, an illustrative bandwidth configuration table 60 is shown in FIG. 3. As can be observed from FIG. 3, head-end 105 can allocate the programmable bands to either the upstream direction or the downstream direction by simply selecting one of the bandwidth configurations 61 to 66. For example, selection of bandwidth configuration 61 allocates B0 to the upstream bandwidth and B3 to the downstream bandwidth, while the programmable bands are not used. Similarly, selection of bandwidth configuration 62 allocates B0 and B1 upstream—thus increasing the bandwidth available for upstream communications, while B3 is allocated to the downstream bandwidth. As further illustration, all of the bandwidth configurations are shown in FIGS. 4-9. In the context of these figures, the suffix “u” or “d” is attached to the band B13 or B2 as appropriate to further indicate whether B1 or B2 is allocated to the upstream or downstream directions, respectively. It should be observed that bands B3 and B0 always pass through to allow communication to and from the head end of the system. Although this is not required for the inventive concept, this facilitates communication in case of a fault in the system.

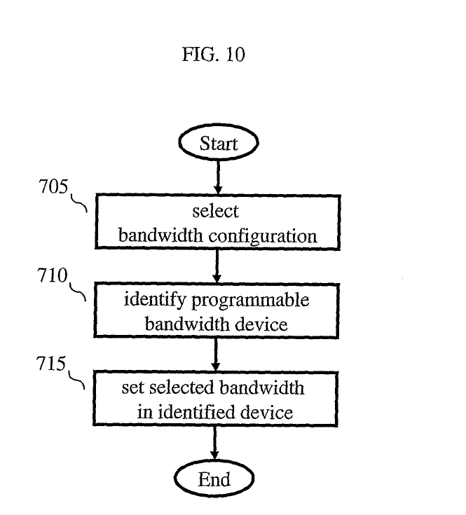

Referring now to FIG. 10, an illustrative method for use in cable system 100 in accordance with the principles of the invention is shown. In step 705, head-end 105 selects a bandwidth configuration for use on at least a portion of the cable network. The actual selection process is not relevant to the inventive concept. However, as illustration, bandwidth can be modified to reallocate bandwidth from downstream communications to upstream communications and vice-versa. This allocation could be performed as a function of actual use, e.g., if a demand for pay-per-view services are low; or as a function of a schedule, e.g., at different times of the day; or to provide additional features, such as peer-to-peer communications in different portions of the cable network between particular groups of users. In step 710, head-end 105 identifies a PBW device of the cable network, e.g., PBW device 200 of FIG. 1, which is associated with the portion of the cable network in which the selected bandwidth configuration will be applied. As noted above, and other than the inventive concept, the identification, location and control of devices in a particular portion of the cable network is known. Finally, in step 715, head-end 105 sets the identified device to the selected bandwidth configuration via the out-of-band signaling channel.

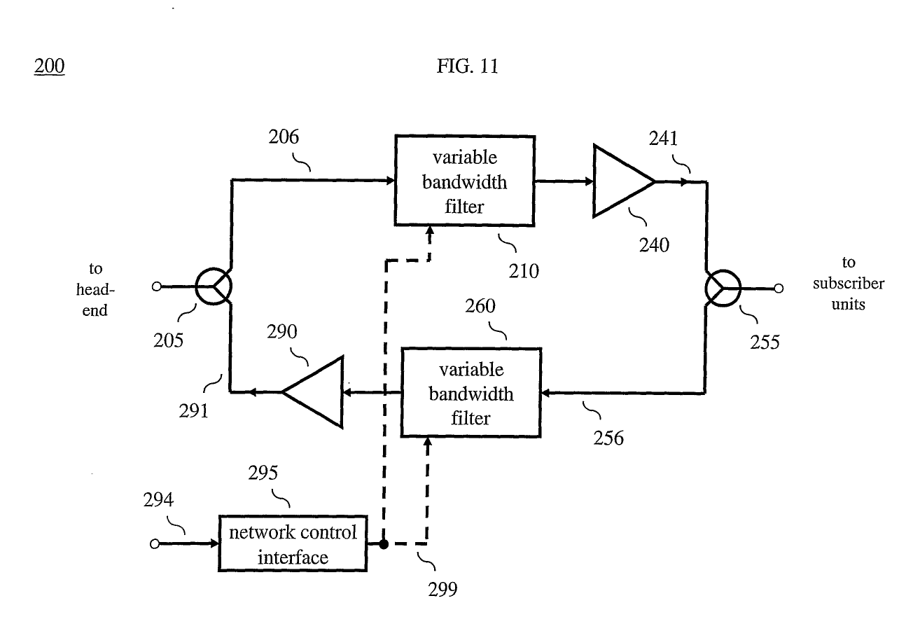

Turning now to FIG. 11, an illustrative block diagram of PBW 200 is shown. PBW 200 comprises directional couplers 205 and 255, amplifiers 240 and 290, variable bandwidth filters 210 and 260 and network control interface 295. In the downstream direction, directional coupler 205 provides a downstream signal 206 that is filtered by variable bandwidth filter 210 and provided (via amplifier 240) for distribution downstream via directional coupler 255. Similarly, in the upstream path, directional coupler 255 provides an upstream signal 256 that is filtered by variable bandwidth filter 260 and provided (via amplifier 290) for transmission upstream via directional coupler 205. In accordance with the principles of the invention, the variable bandwidth filters of PBW 200 filter the upstream and downstream signals to, in effect, alter the available bandwidth over one, or more, portions of the cable network in accordance with one of the above-described bandwidth configurations as illustrated in table 60 of FIG. 3. In particular, the bandwidth, or pass band (frequency range), of each variable bandwidth filter is controlled by network control interface 295 via control signal 299. Network control interface 295 is responsive to the above-mentioned out-of-band signaling channel (represented by signal 294) for setting PBW 200 to the bandwidth configuration selected by the head-end. In this regard, the out-of-band signaling channel is modified to include predefined commands that are associated with each of the bandwidth configurations shown in table 60 of FIG. 3.

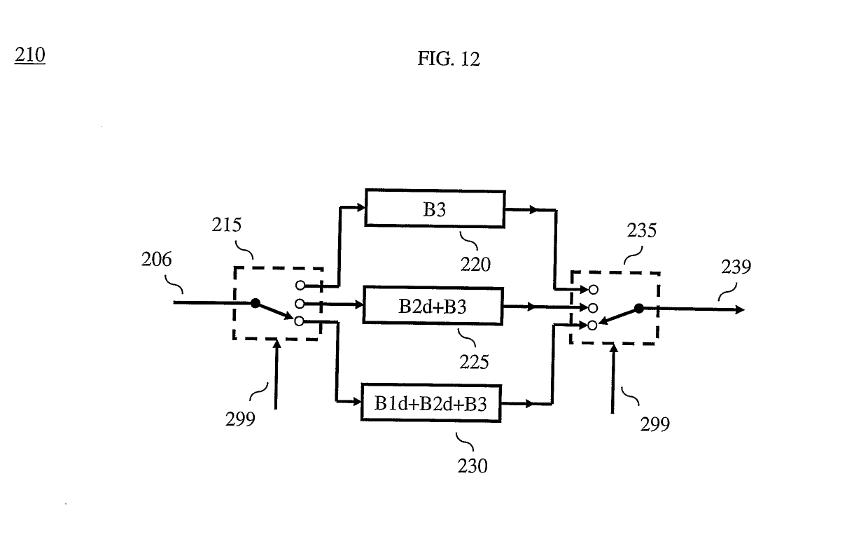

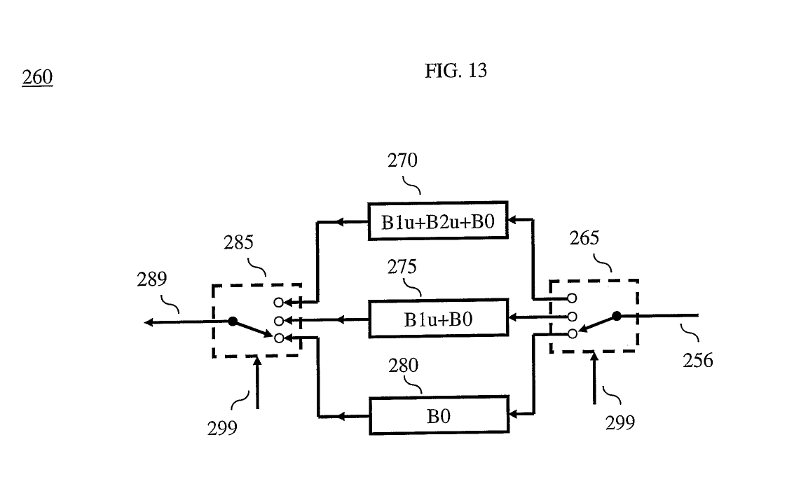

As described above, the bandwidth of each variable bandwidth filter of PBW 200 is set to conform to a bandwidth configuration selected by the head-end. In this regard, illustrative embodiments of variable bandwidth filter 210 and variable bandwidth filter 260 are shown in FIGS. 12 and 13, respectively. As can be observed from FIG. 12, variable bandwidth filter 210 comprises a bank of filters 220, 225 and 230, along with multiplexers 215 and 235, which are controlled via control signal 299. As shown in FIG. 12, the multiplexers are used to route the signal through one of the filters as determined by control signal 299. Each filter has a pass band that corresponds to one of the downstream bands found in table 60 of FIG. 3 (again, the suffix d denotes the filter is in the downstream path). For example, if the head-end selects bandwidth configuration 61 of table 60 of FIG. 3, then filter 220 is selected via the out-of-band signaling channel through network control interface 295 and control signal 299. Likewise, if the head-end selects bandwidth configuration 65 of table 60 of FIG. 3, then filter 220 is selected via the out-of-band signaling channel, etc.

Similar comments apply to variable bandwidth filter 260 shown in FIG. 13. In particular, variable bandwidth filter 260 comprises a bank of filters 270, 275 and 280, along with multiplexers 265 and 285, which are controlled via control signal 299. As shown in FIG. 13, the multiplexers are used to route the signal through one of the filters as determined by control signal 299. Each filter has a pass band that corresponds to one of the upstream bands found in table 60 of FIG. 3 (again, the suffix u denotes the filter is in the upstream path). For example, if the head-end selects bandwidth configuration 61 of table 60 of FIG. 3, then filter 280 is selected via the out-of-band signaling channel through network control interface 295 and control signal 299. Likewise, if the head-end selects bandwidth configuration 63 of table 60 of FIG. 3, then filter 270 is selected via the out-of-band signaling channel, etc.

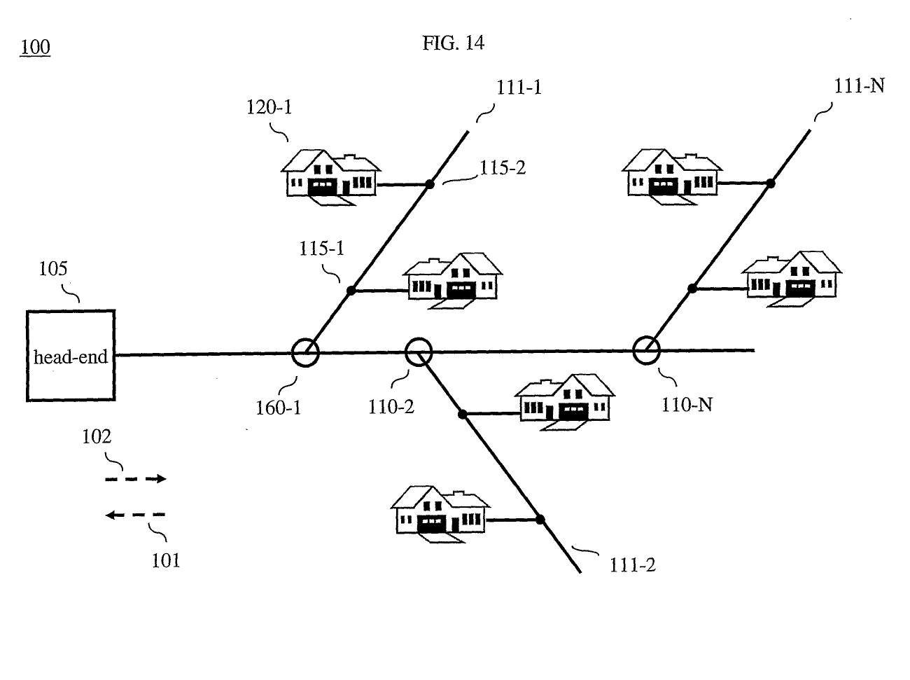

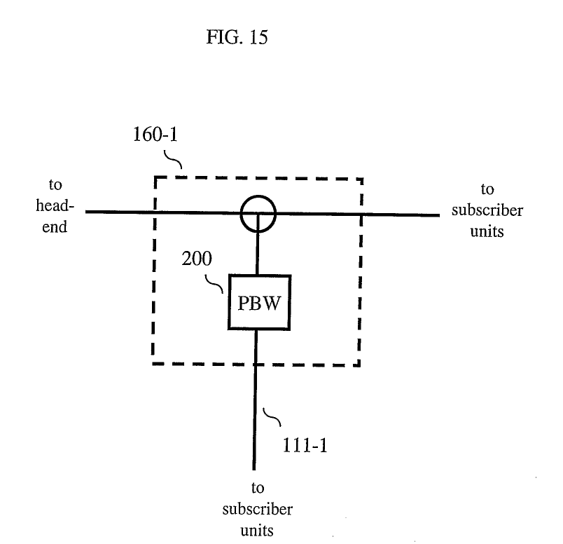

As noted above, a cable system may have one, or more, PBW devices located in one, or more, portions of the cable network. Illustratively, FIG. 1 shows a PBW device located in a portion of the main coaxial cable. Another illustrative location and type of PBW device is shown in FIG. 14. The elements in FIG. 14 are similar to those found in FIG. 1 except for tap 160-1, which serves feeder cable 111-1. Tap 160-1 is shown in more detail in FIG. 15. As can be observed from FIG. 15, tap 160-1 comprises PBW 200 (described above). Thus, and in accordance with the principles of the invention, tap 160-1 is used to manage the bandwidth on feeder cable 111-1.

As described above, the inventive concept provides the ability to extend the capabilities of cable networks by increasing symmetry in the network and distributing serving capability throughout the network. Illustratively, the cable spectrum is divided into multiple bands, and band direction (upstream or downstream) can be electronically selected by a device of the cable network such as, but not limited to, a tap. This enables the cable network to better adapt to the traffic demands of upstream and downstream services, and allow for new distribution of local services. For example, downstream bandwidth can be increased at the expense of upstream bandwidth. It should be noted that although the inventive concept was described in the context of a fixed downstream band (B3), a fixed upstream band (B0) and a number of programmable bands (B1 and B2), the inventive concept is not so limited. For example, all of the bands can be programmable. Further, although the inventive concept was described in the context of application to a traditional cable system, the inventive concept is not so limited and is applicable to any form of network, even, e.g., a home network, campus network, etc.

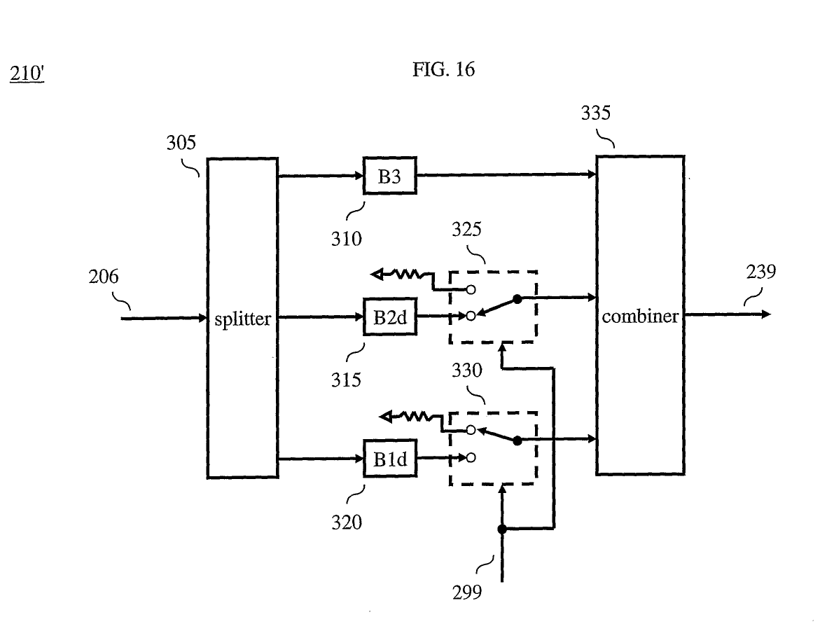

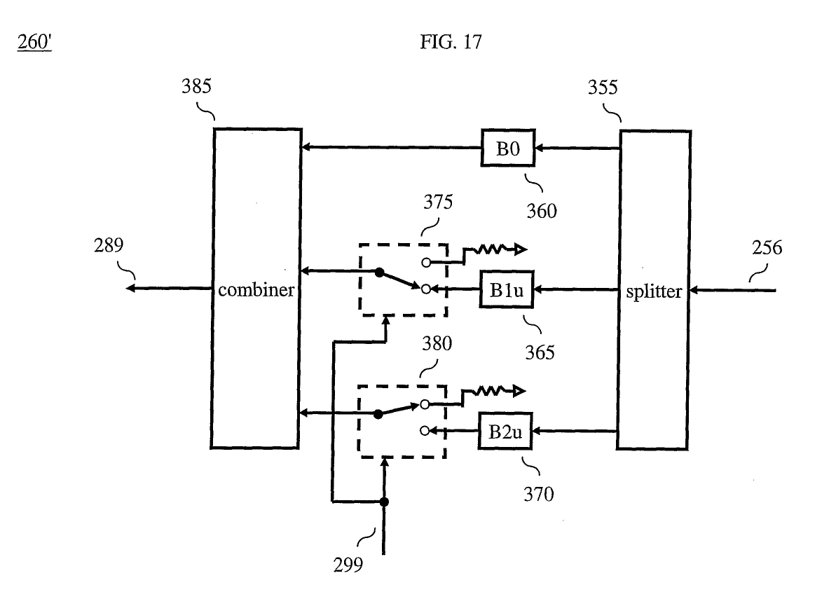

Other illustrative embodiments of a PBW device in accordance with the principles of the invention are shown in FIGS. 16-20. First, FIGS. 16 and 17 show alternative embodiments for use in the variable bandwidth filters 210 and 260, respectively. These alternative embodiments have the labels 210′ and 260′ as appropriate. In FIG. 16, variable bandwidth filter 210′ comprises a splitter 305, a set of filters 310, 315 and 320, multiplexers 325 and 330 and a combiner 335. The downstream signal 206 is applied to splitter 305, which splits the signal for application to each filter. As shown in FIG. 16, filter 310 has a pass band B3; filter 315 has a pass band B2 (again, the suffix d denoting the filter is in the downstream path) and filter 320 has a pass band B1. Multiplexers 325 and 330 are controlled via control signal 299 to either pass or block signals from their respective filters for application to combiner 335. The latter combines any applied signals and forms the downstream signal 239. For example, if bandwidth configuration 64 is selected then multiplexer 325 applies the signal from filter 315; while multiplexer 330 blocks any signal from filter 320. As a result, combiner 325 provides a downstream signal 239 having a bandwidth of B3+B2.

Likewise, in FIG. 17, variable bandwidth filter 260′ comprises a splitter 355, a set of filters 360, 365 and 370, multiplexers 375 and 380 and a combiner 385. The upstream signal 256 is applied to splitter 355, which splits the signal for application to each filter. As shown in FIG. 17, filter 360 has a pass band B0; filter 365 has a pass band B1 (again, the suffix u denoting the filter is in the upstream path) and filter 370 has a pass band B2. Multiplexers 375 and 380 are controlled via control signal 299 to either pass or block signals from their respective filters for application to combiner 385. The latter combines any applied signals and forms the upstream signal 289. For example, if bandwidth configuration 62 is selected then multiplexer 375 applies the signal from filter 365; while multiplexer 380 blocks any signal from filter 370. As a result, combiner 385 provides an upstream signal 289 having a bandwidth of B0+B1.

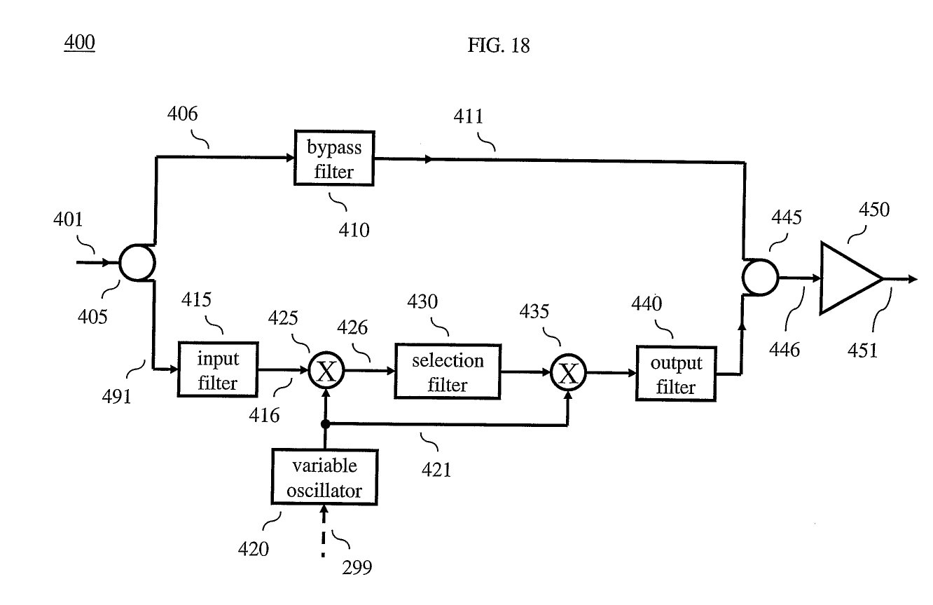

Turning now to FIG. 18, another illustrative embodiment of a PBW device is shown. For simplicity, transmission is shown and described in only one direction, e.g., upstream. The arrangement of elements in the device for downstream transmission is similar and not described herein (nor shown in FIG. 18). PBW 400 comprises a splitter 405, an input filter 415, mixers (or multipliers) 425 and 435, a variable oscillator 420, a selection filter 430, an output filter 440, a combiner 445 and an amplifier 450. PBW 400 illustrates a tunable band selection filter and amplifier that uses variable oscillator 420 to shift the frequency region of the signal applied to selection filter 430.

An upstream signal 401 is applied to splitter 405, which splits the signal into signals 406 and 491 for application to bypass filter 410 and input filter 415, respectively. Bypass filter 410 is a low pass filter for upstream use and, e.g., has a pass band of B0 (conversely, bypass filter 410 would be a high pass filter for downstream use). As a result, bypass filter 410 provides a signal 411 restricted to the frequency region B0. The input filter 415 has a bandwidth corresponding to one, or more, of the above-described programmable bands and is used to restrict downstream signal 491 to the corresponding frequency range. For example, input filter 415 may have a bandwidth equal to B1+B2 with the result that output signal 416 from input filter 415 represents any upstream components present in that frequency range. The output signal 416, along with a sinusoidal signal 421 from variable oscillator 420, is applied to multiplier (mixer) 425. The later frequency shifts output signal 416 as a function of the frequency of sinusoidal signal 421 to provide a signal 426 to selection filter 430. Signal 426 is also referred to herein as the “conversion image” of signal 416. As a result, by changing the frequency of variable oscillator 420 the frequency range of signal 426 can be shifted such that selection filter 430 filters some, all, or none of the signal components in output signal 416. The selection filter can be low pass, high pass, or band pass. All that matters is that the conversion image, either inverted or non-inverted spectrum, can be frequency shifted before application to selection filter 430 to, in effect, change the bandwidth of the system. The output signal (if any) from selection filter 430 is re-mixed down to the original frequency range, via mixer 435, and applied to output filter 440. The latter has a bandwidth similar to input filter 415 and is used to reject any undesired images as a result of the second mixing, or conversion, process. The output signals from bypass filter 411 and output filter 440 are formed back into an upstream signal 451 via combiner 445 and amplifier 450.

As a more concrete example of PBW 400, a programmable upstream filter enabling the selection of the 42 to 108 MHz range comprises: a bypass filter 410 having a pass band in the range of 5-42 MHz; an input filter 415 having a pass band in the range of 42 to 108 MHz; a selection filter 430 having a 72 MHz bandwidth centered at 140 MHz (similar to a commercially available Sawtek 856314 filter) (also, ideally, the center frequency would be slightly higher to avoid oscillator leakage to the output); an output filter 440 having cutoff frequency above 108 MHz; and a variable oscillator 420 that can be set to 212 MHz to shift the inverted image to the pass band of selection filter 430. As the frequency of variable oscillator 420 is decreased (e.g., via control signal 299) the spectrum of the inverted image signal 426) will decrease in frequency, shifting what was the high end of the 42 to 108 MHz band out of the pass band of selection filter 430, and, by the time the frequency reaches 146 MHz, selection filter 430, in effect, blocks the entire pass band.

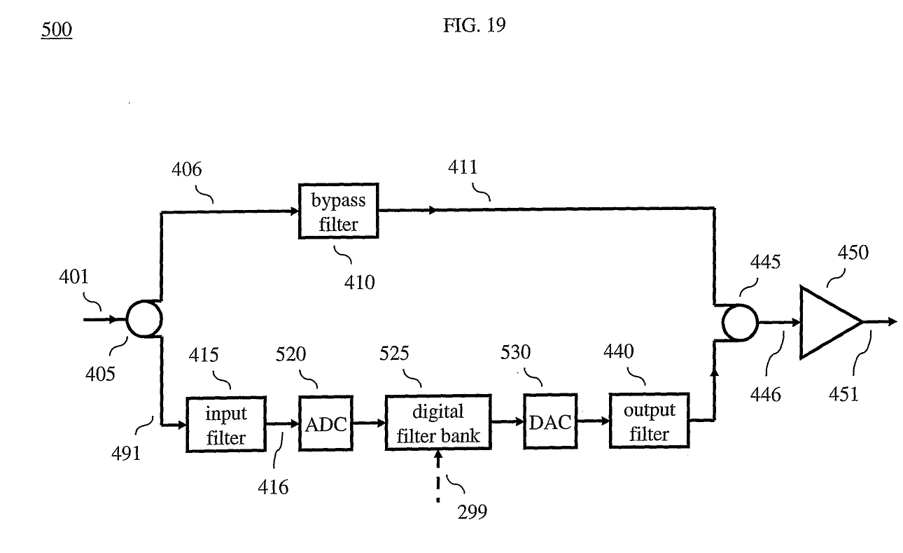

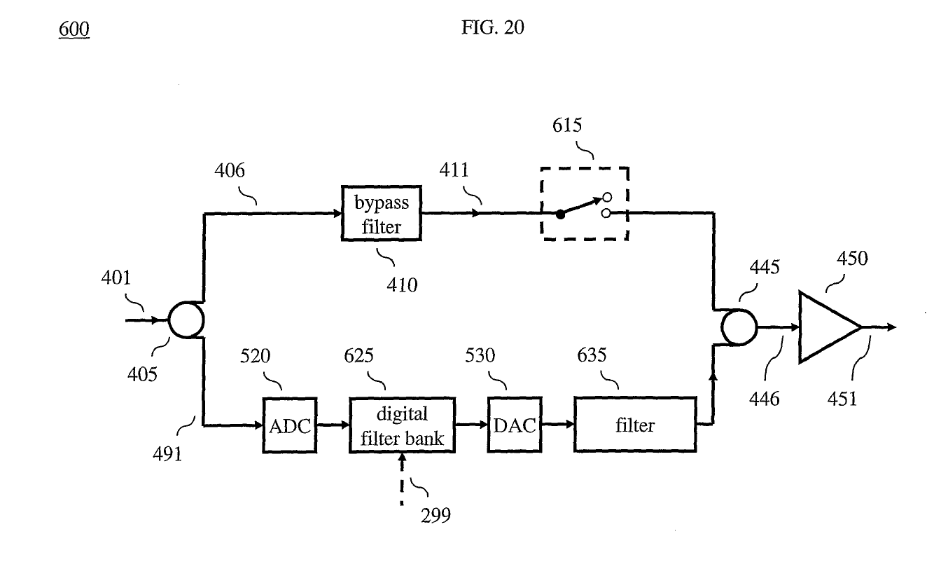

Other illustrative embodiments are shown in FIGS. 19 and 20. Again, for simplicity, only the upstream processing is shown and described. PBW 500 of FIG. 19 is similar to PBW 400 of FIG. 18 except that a digital filter bank 525 is used for the band selection filter, which is controlled via control signal 299. Conversion to, and from, the digital domain is performed by analog-to-digital converter (ADC) 520 and digital-to-analog converter (DAC) 530, respectively. It should be noted that in implementing digital filter bank 525 it may be necessary to compensate for the delay through bypass filter 410. Turning now to FIG. 20, PBW 600 represents an implementation using a digital signal processor (DSP) for all filters, eliminating the need for bypass filter 410. However, as shown in FIG. 20, bypass filter 410 may be switched in (via switch 615) in the event of a failure.

As such, the foregoing merely illustrates the principles of the invention and it will thus be appreciated that those skilled in the art will be able to devise numerous alternative arrangements which, although not explicitly described herein, embody the principles of the invention and are within its spirit and scope. For example, although illustrated in the context of separate functional elements, these functional elements may be embodied in one or more integrated circuits (ICs). Similarly, although shown as separate elements, any or all of the elements may be implemented in a stored-program-controlled processor, e.g., a digital signal processor (DSP) or microprocessor that executes associated software, e.g., corresponding to one or more of the steps shown in FIG. 10. Further, although shown in particular configurations, the elements therein may be distributed in different units in any combination thereof. For example, downstream bandwidth management may be performed in a device separate from a device performing upstream bandwidth management. It is therefore to be understood that numerous modifications may be made to the illustrative embodiments and that other arrangements may be devised without departing from the spirit and scope of the present invention as defined by the appended claims.

1. Apparatus for use in a network, the apparatus comprising:
a controller for receiving a control signal, the control signal representative of a selected one of a plurality of network bandwidth configurations; and
a variable bandwidth filter for processing at least one of an upstream signal of the network and a downstream signal of the network in accordance with the selected network bandwidth configuration.

2. The apparatus of claim 1, wherein the variable bandwidth filter includes a bank of filters, each filter of the bank operating over a different frequency range.

3. An apparatus for use in managing bandwidth in a cable system, the apparatus comprising:
a first port for coupling to an upstream portion of a cable network and for receiving a downstream signal;
a second port for coupling to a downstream portion of the cable network and receiving an upstream signal; and
a filter for filtering at least one of the downstream signal and the upstream signal;
wherein the filter has a bandwidth that is adjustable in accordance with a plurality of cable network bandwidth configurations, each cable network bandwidth configuration allocating bandwidth differently between upstream communications and downstream communications over at least a portion of the cable network.

4. The apparatus of claim 3, further comprising:
a network control interface, responsive to a control signal representing a selected one of the plurality of cable network bandwidth configurations, for adjusting the bandwidth of the filter in accordance with the selected cable network bandwidth.

5. The apparatus of claim 4, the filter further comprising:
a bank of selectable filters, each selectable filter operating over a different frequency range;
wherein the network control interface selects at least one of the selectable filters for adjusting the bandwidth of the filter in accordance with the selected cable network bandwidth

6. The apparatus of claim 3, further comprising:
an amplifier for amplifying an output signal of the filter for transmission on the portion of the cable network.

7. The apparatus of claim 3, the filter further comprising:
a downstream filter for filtering the downstream signal; and
an upstream filter for filtering the upstream signal;
wherein at least one of the downstream filter and the upstream filter has the adjustable bandwidth.

8. The apparatus of claim 7, further comprising:
a downlink transmitter for amplifying an output signal of the downstream filter for transmission via the second port; and
an uplink transmitter for amplifying an output signal of the upstream filter for transmission via the first port.

9. The apparatus of claim 3, wherein the filter adjusts bandwidth by use of an oscillator for frequency shifting at least one of the downstream signal and the upstream signal.

10. The apparatus of claim 3, wherein the filter comprises a digital filter bank.

11. The apparatus of claim 10, further comprising a digital signal processor for implementing the filter.

12. A method for use in managing bandwidth in a system, the method comprising:
receiving a control signal representing a selected one of a plurality of network bandwidth configurations, each network bandwidth configuration allocating bandwidth differently between upstream communications and downstream communications over at least a portion of a network; and
filtering at least one of a downstream signal and a upstream signal of the network using the selected bandwidth.

13. The method of claim 12, wherein the receiving step further comprises:
selecting at least one filter from a bank of filters in accordance with the selected bandwidth for use in the filtering step.

14. The method of claim 12, wherein the receiving step further comprises:
frequency shifting at least one of a downstream signal and an upstream signal in accordance with the selected bandwidth configuration.

15. The method of claim 12, wherein the filtering step digitally filters at least one of a downstream signal and an upstream signal.

16. The method of claim 12, wherein the filtering step provides an output signal, the method further comprising:
amplifying the output signal for transmission on the portion of the network.

17. The method of claim 12, the filtering step further comprising:
(a) filtering the downstream signal; and
(b) filtering the upstream signal;
wherein at least one of steps (a) and (b) uses the selected bandwidth.

18. The method of claim 17, where step (a) provides a downstream signal and step (b) provides an upstream signal, the method further comprising:
amplifying the downstream signal for transmission downstream; and
amplifying the upstream signal for transmission upstream.

19. A method for use in a cable system, the method comprising:
selecting one of a plurality of network bandwidth configurations for use on at least a portion of the cable system;
identifying a device located in the portion of the cable system; and
setting the identified device to process at least one of an upstream signal and a downstream signal in accordance with the selected network bandwidth configuration.

20. The method of claim 19, wherein the setting step includes the step of:
sending an out-of-band control signal to the identified device, the out-of-band control signal representative of the selected network bandwidth configuration.
